(19) United States
(12) Patent Application Publication
(10) Pub. No.: US 2025/0230099 A1
(43) Pub. Date: Jul. 17, 2025

(54) GEOPOLYMER-BASED CONCRETE COMPOSITION

(71) Applicant: Plantaer Inc., Brooklyn, NY (US)

(72) Inventors: Robert Joseph Abdallah, Brooklyn, NY (US); Manuel Jesus Benitez Ruiz, Lauderhill, FL (US)

(21) Appl. No.: 19/058,500

(22) Filed: Feb. 20, 2025

Related U.S. Application Data
(60) Provisional application No. 63/614,572, filed on Dec. 23, 2023.

(51) Int. Cl. C04B 28/00; C04B 12/00; C04B 18/08; C04B 18/10; C04B 18/14; C04B 22/06; C04B 24/38; C04B 103/00; C04B 103/30; C04B 111/00; C04B 111/40

(52) U.S. Cl. CPC C04B 28/006; C04B 12/005; C04B 18/08; C04B 18/101; C04B 18/141; C04B 22/068; C04B 24/383; C04B 2103/0051; C04B 2103/304; C04B 2111/00017; C04B 2111/40

(57) ABSTRACT

Embodiments provide a novel concrete composition and method for forming a geopolymer-based building material. The composition comprises a geopolymer binder, water-retentive aggregates with long-term water retention properties and biological surface growth facilitation, where at least one aggregate is cellulose pre-treated with a saturating coating solution. The composition also includes rigid, porous aeration aggregates and strength aggregates. The method involves mixing these components to form a pourable building material, which is then poured and cured under controlled conditions to create a durable, cured building material. Embodiments include a geopolymer-based construction material comprising an aluminosilicate precursor, an activator, biopolymer-coated water-retentive aggregates, and a porosity agent. Said geopolymer-based construction material retains water above 10% by weight with a pH below 8.0, offering enhanced sustainability, biological compatibility, and durability in construction applications.

### CROSS-REFERENCE TO RELATED APPLICATIONS

This application claims the benefit of and priority to provisional application 63/614,572, filed 23 Dec. 2023, the entire contents of which are hereby incorporated by reference for all purposes as if fully set forth herein.

### TECHNICAL FIELD

One technical field is geopolymer-based construction materials, specifically concrete compositions incorporating water-retentive aggregates, biological growth media, and aeration agents. Other technical fields are methods for manufacturing and curing such materials, as well as their use in building systems with environmental sensors and irrigation mechanisms.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Conventional Ordinary Portland Cement (OPC) concrete is widely used in modern construction but poses significant environmental and functional challenges. These include high CO₂ emissions, water impermeability leading to urban heat islands and increased stormwater runoff, and limited suitability for biological applications. Existing urban greening solutions are complex and costly, requiring multiple layers for waterproofing, drainage, and growing media. Moreover, traditional geopolymer alternatives face issues like high alkalinity, poor water retention, inadequate porosity, and lack of integrated monitoring for biological growth. There is a critical need for a more sustainable, efficient construction material that overcomes these challenges and supports biological growth with minimal maintenance.

### SUMMARY

The appended claims may serve as a summary of the invention.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a cross-sectional view of the microstructure of a geopolymer matrix, according to an embodiment.

FIG. 2 exemplarily illustrates a process flow diagram depicting the manufacturing sequence according to an embodiment.

FIG. 3A and FIG. 3B exemplarily illustrate a detailed production process diagram illustrating the aggregate coating, porosity development, and post-processing method, according to an embodiment.

### DETAILED DESCRIPTION OF EXAMPLE EMBODIMENTS

A description of embodiments will now be given with reference to the Figures. It is expected that the disclosure may be embodied in other specific forms without departing from its spirit or essential characteristics. The described embodiments are to be considered in all respects only as illustrative and not restrictive.

An embodiment provides an improved geopolymer-based construction material that incorporates water-retentive aggregates, biological growth mediums, and controlled porosity, overcoming the limitations of conventional OPC and existing urban greening systems. This new material reduces environmental impact by utilizing aluminosilicate precursors for the binder, enhancing water retention, bioactivity, and structural integrity. Additionally, it integrates autonomous monitoring capabilities through environmental sensors, reducing maintenance costs and supporting sustainable, biologically active urban spaces with optimized growth conditions. This innovative approach addresses the need for both sustainable construction and efficient urban greening solutions.

An embodiment relates to a concrete composition that incorporates a geopolymer binder, water-retentive aggregates, aeration aggregates, and strength aggregates. The water-retentive aggregates used in this composition are capable of long-term water retention and facilitate biological surface growth. At least one of these water-retentive aggregates is cellulose pre-treated with a saturating coating solution. The concrete composition comprises an alkaline solution, which is a component of the geopolymer binder. Moreover, hydrogen peroxide may be added to the mixture to promote aeration, and a biological growth medium, including natural polysaccharides or dairy-based products, can be incorporated. This biological medium is a biodegradable adhesive layer affixed to the concrete composition in a cured state. In one embodiment, the cellulose used in the composition comprises recycled cellulose.

In another embodiment, a method for forming a cured building material is also provided. This method involves mixing the geopolymer binder with water-retentive aggregates, including cellulose pre-treated with a saturating solution, along with rigid, porous aeration aggregates and strength aggregates. Once mixed, the pourable building material is poured into molds, and the material is cured in a controlled environment to achieve the final cured state. The method comprises an alkaline solution, which is a component of the geopolymer binder and/or hydrogen peroxide during mixing (before pouring). After curing, an acid wash may be applied to neutralize the pH of the cured material. Additionally, a biological growth medium can be applied to the cured surface, adhering via its biodegradable adhesive mechanisms.

In another embodiment, a geopolymer-based construction material comprises an aluminosilicate precursor, an activator, water-retentive aggregates with a biopolymer coating, and a porosity agent. The water-retentive aggregates can include materials like cellulose, peat moss, coconut coir, biochar, or zeolites, with the biopolymer coating potentially incorporating chitosan. This material exhibits a water retention rate above 10% by weight and has a pH below 8.0. The aluminosilicate precursor may be selected from metakaolin, fly ash, slag, volcanic ash, rice husk ash, or red mud, while the activator typically consists of an alkali or acid-based solution. A porosity agent, such as hydrogen peroxide, expanded clay, or perlite, is included to promote controlled aeration.

A process for manufacturing the geopolymer-based construction material is also provided. The process involves mixing the aluminosilicate precursor with the activator, adding the water-retentive aggregates with a biopolymer coating, and introducing a porosity agent. The mixture is then cured, and an acid wash is applied to neutralize the pH of the material after curing. In one embodiment, the curing process occurs at temperatures between 60° C. and 90° C. for a duration of 2 to 72 hours, followed by an acid wash using acetic or citric acid at ambient temperature or higher temperatures (60° C. to 100° C.) for a specified period.

In another embodiment, a building system incorporates the geopolymer-based construction material. This system consists of multiple building elements formed from the material, as well as environmental sensors and an irrigation system. The building elements may include roof pavers, facade panels, roofing tiles, or infrastructure surface coatings, and the sensors may monitor various environmental factors such as wind speed, temperature, humidity, or even infrared or hyperspectral data. The irrigation system is equipped with drip or misting emitters, controlled by a system that uses sensor data and machine learning algorithms to optimize activation and maintenance, further enhancing sustainability and the biological activity of the building system.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

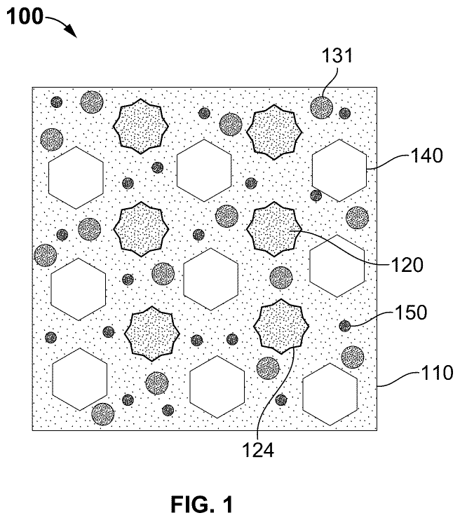

Referring to FIG. 1, a cross-sectional view illustrates the microstructure of a geopolymer matrix or concrete composition 100, highlighting its composition and structural organization. The concrete composition 100 consists of a geopolymer binder (cement or slurry) 110, water-retentive aggregates 120, an aggregate coating 124, chemical aeration agents 131, aeration aggregates 140, and strength aggregates 151. In one embodiment, the water-retentive aggregates 120 enable long-term moisture retention and support biological growth. At least one of these aggregates 120 is cellulose pre-treated with a saturating coating solution. Additionally, the composition 100 comprises an alkaline solution, which is a component of the geopolymer binder. Hydrogen peroxide 131 can be introduced to promote aeration, while a biological growth medium, such as natural polysaccharides or dairy-based products, can be incorporated. This biological medium is a biodegradable adhesive layer affixed to the concrete composition in a cured state. In one embodiment, the cellulose component of composition 100 consists of recycled cellulose.

In one embodiment, a geopolymer cement or binder 110 is composed of aluminosilicate precursors, including calcined or natural pozzolanic materials such as metakaolin (Al₂O₃·2SiO₂), Class F and Class C fly ash, ground granulated blast furnace slag (GGBFS), volcanic ash, rice husk ash (RHA), red mud (bauxite residue), diatomaceous earth, pumice, zeolite, and other calcined clays. These precursors supply silica (SiO₂) and alumina (Al₂O₃), which are essential for geopolymerization. Additionally, if used, calcium-rich materials such as GGBFS, Class C fly ash, and red mud influence setting kinetics and mechanical properties by forming calcium silicate hydrate (C-S-H) and calcium aluminosilicate hydrate (C-A-S-H) phases, enhancing strength development and long-term durability.

Alkali activation typically involves sodium silicate (Na₂SiO₃), potassium silicate (K₂SiO₃), or a combination, often also combined with sodium hydroxide (NaOH) or potassium hydroxide (KOH), with optimal SiO₂/Na₂O or SiO₂/K₂O ratios tailored to the desired properties and application. Alternative activators, such as sodium carbonate (Na₂CO₃), calcium oxide (CaO), calcium hydroxide (Ca(OH)₂), and magnesium oxide (MgO), influence workability, setting time, and strength development. The reaction pathway involves the dissolution of silica and alumina from the precursor material, followed by the formation of sodium or potassium aluminosilicate hydrate gels (N-A-S-H or K-A-S-H), which harden through polycondensation. While some researchers distinguish geopolymers from alkali-activated materials based on differences in chemistry and structure, others explore sustainable activators and industrial by-products to improve the environmental profile of geopolymer production.

Alternatively, acid-based activation primarily utilizes phosphoric acid (H₃PO₄) at varying concentrations, forming silico-aluminophosphate structures instead of traditional N-A-S-H or K-A-S-H gels. This process enhances thermal stability, acid resistance, and mechanical strength compared to alkali-activated geopolymers. Other acids, such as sulfuric acid (H₂SO₄), hydrochloric acid (HCl), citric acid (C₆H₈O₇), oxalic acid (C₂H₂O₄), and acetic acid (CH₃COOH), have been explored for additional applications. The precursor-to-activator ratio, often expressed as the liquid-to-solids (L/S) ratio, along with reaction temperature (ambient to ˜90° C.) and curing conditions, significantly impacts the final microstructure, porosity, and mechanical performance of the geopolymer cement. Phosphoric acid-activated geopolymers show promise for enhanced durability and acid resistance; however, further research is needed to optimize their performance and scalability.

In some embodiments, one or more chemical aeration agents 131 are incorporated into the matrix. In one embodiment, gas-generating agents such as hydrogen peroxide (H₂O₂: 2H₂O₂→2H₂O +O₂), sodium bicarbonate (NaHCO₃), or aluminum powder (2Al+6H₂O+2OH⁻→2[Al(OH)₄]⁻+3H₂) are introduced to create controlled porosity. This engineered porosity optimizes the pore structure, enhancing water distribution and promoting organism viability. However, achieving a fully interconnected open-cell porous structure requires additional modifications. Hardening agents such as calcium oxide (CaO) are incorporated to accelerate binder setting. By synchronizing the accelerated setting time with chemical aeration and heat curing, the matrix begins to harden while elevated temperatures rapidly decompose gas-generating agents (e.g., H₂O₂). This simultaneous hardening and gas evolution process causes bubbles to expand and rupture, forming an interconnected porous network. This engineered microstructure enables water penetration and absorption by water-retentive aggregates, improving fluid transport properties and overall performance.

In one embodiment, the water-absorbing aggregates, also referred to as water-retentive aggregates 120, consist of organic and mineral components designed to enhance moisture retention and bio-receptivity. Organic aggregates, such as biochar, peat moss, coconut coir, and cellulose fibers, provide high water-holding capacity and gradual moisture release. Mineral-based options, including bentonite clay and zeolites, contribute to ion exchange capacity and long-term hydration control. To improve durability and prevent premature degradation during curing, these aggregates are coated with a 0.5-2% chitosan solution prepared in 1-5% acetic acid. This coating stabilizes the aggregates throughout the curing phase while preserving their water absorption properties after setting, ensuring sustained hydration for plant colonization.

In some embodiments, the aerating aggregates 140 are selected to introduce controlled porosity, enhancing water permeability, air circulation, and microbial habitat formation. These include vermiculite, perlite, expanded clay, and shale, lightweight materials with a high void fraction. When incorporated into the geopolymer matrix, these aggregates reduce bulk density, increase capillary action, and improve moisture retention without compromising structural integrity. The resulting pore network facilitates root penetration and microbial colonization, making the system ideal for bio-receptive applications.

In one embodiment, the strength aggregates 150 are incorporated to ensure mechanical stability and load-bearing capacity. These include sand, gravel, and crushed stone, which enhance compressive strength, abrasion resistance, and dimensional stability. Aggregate size and grading are optimized to balance mechanical performance with permeability, ensuring durability and environmental adaptability. These structural components provide longevity in high-exposure environments while maintaining the necessary integrity for architectural and infrastructure applications.

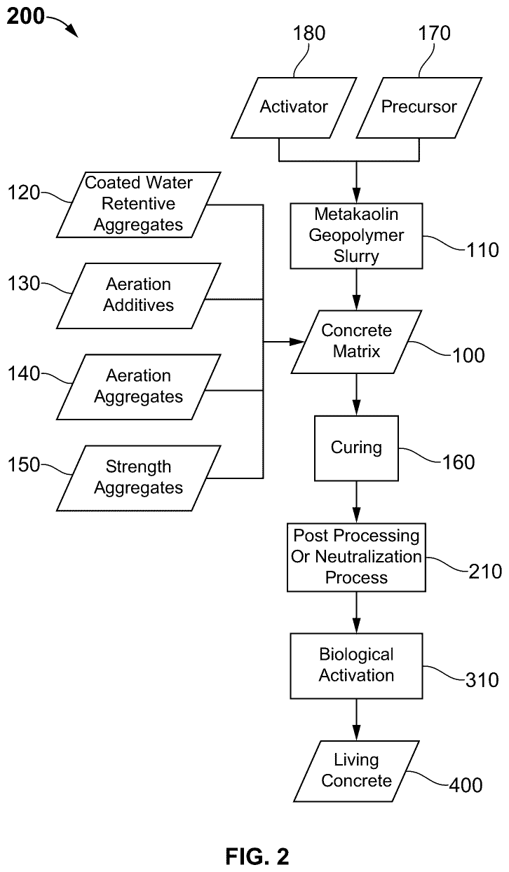

Referring to FIG. 2, a process flow chart 200 illustrates the manufacturing sequence. In one embodiment, the production process begins by mixing a precursor 170 with an activator 180 to initiate geopolymerization. The precursor 170, typically an aluminosilicate material such as metakaolin, is combined with an alkali-based activator 180. The mixture is blended at high speed for at least five minutes to ensure uniform dispersion, forming a metakaolin geopolymer slurry 110, which serves as the base matrix for further material modifications. A hardening agent is then added to accelerate the setting time.

In one embodiment, to optimize water retention, aeration, and structural integrity, controlled porosity is introduced using aeration additives 130 and mixed under low agitation. Once the desired porosity is achieved, aggregates, including coated water-retentive aggregates 120 (e.g., cellulose, zeolite), aeration aggregates 140 (e.g., perlite, pumice, expanded clay), and strength aggregates 150 (e.g., basalt, quartz sand), are gradually incorporated to maintain the pore structure. The mixture is then thoroughly distributed, as shown in FIG. 1.

At step 160, the material is cast into molds and undergoes primary curing at 60-90° C. for 2-72 hours. During this phase, the molds are wrapped in plastic to minimize moisture loss, ensuring complete reaction and uniform material properties. The controlled curing temperature accelerates geopolymerization and strength development while stabilizing the matrix and preserving its designed porosity and water-retentive characteristics.

After curing 160, a post-processing or neutralization step 210 is performed to adjust material properties and enhance bio-receptivity. This involves a pH neutralization process using an acid wash (1-10% acetic or citric acid) for 24-48 hours at ambient temperature or 2-12 hours at 60-100° C. This treatment lowers surface alkalinity from pH 10-12 to below pH 8, improving biological compatibility and water retention. Additionally, the controlled acid treatment partially dissolves the biopolymer shell 124, further optimizing the surface for plant colonization and microbial growth.

After curing 160 and neutralization 210, biological activation 310 prepares the surface for plant colonization. The cured material is thoroughly rinsed to remove residual acid and ensure an open-cell pore structure for optimal moisture retention and root adhesion. A living organism slurry (e.g., moss, lichen, microalgae, liverworts, hornworts, and other fungi and bacteria), and a biodegradable growth and adhesive medium such as psyllium, starch-based gel, sodium alginate, glycerin, or other natural polysaccharides or protein-based adhesives, is then applied. The living concrete is maintained under high humidity conditions through misting or ambient moisture retention for 1-12 weeks to facilitate organism colonization. Upon completion, the process yields a fully colonized living concrete product at step 400, demonstrating integrated plant growth on the engineered material.

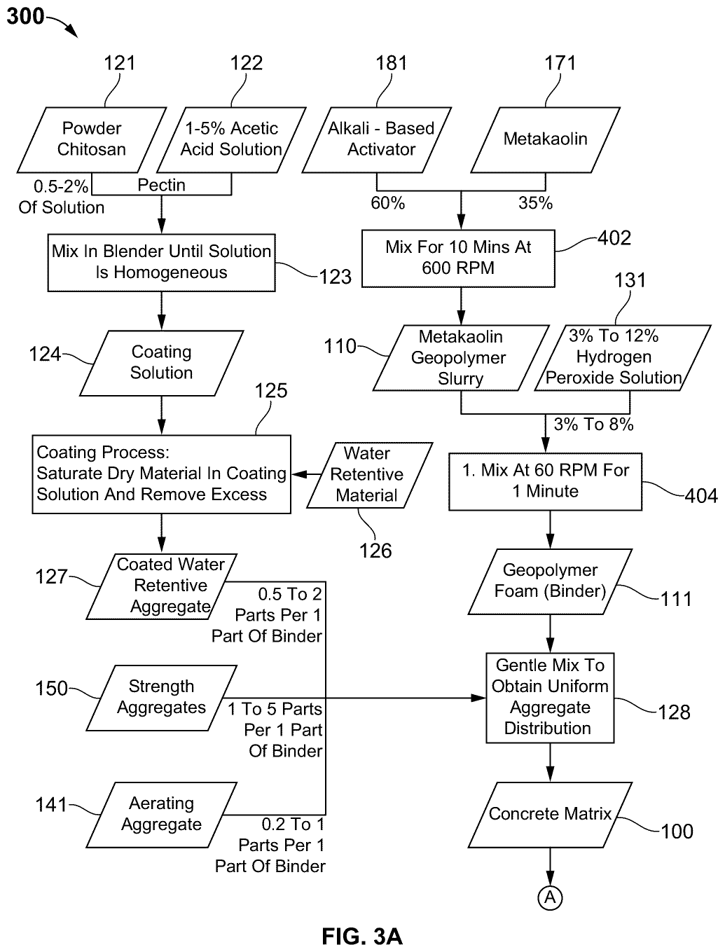

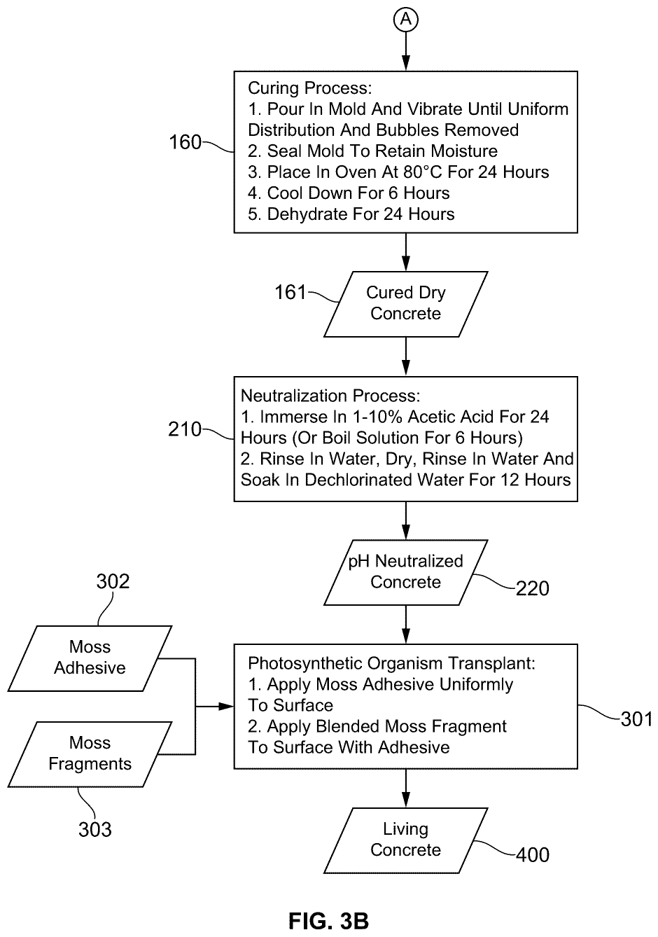

Referring to FIG. 3A and FIG. 3B, a detailed production process 300, including aggregate coating, porosity development, and post-processing, is illustrated. In one embodiment, the process 300 begins with preparing a coating solution 124 for the water-absorbing aggregates 120. This solution is formulated by dissolving powdered chitosan 121 in a 1%-5% acetic acid solution 122, ensuring that chitosan 121 constitutes 0.5% to 2% of the coating solution 124. At step 123, an additional optional step involves the dissolved chitosan being blended with pectin until a homogeneous mixture is achieved. The solution is then heated while continuously stirred until it reaches a boiling temperature, followed by controlled cooling to just above room temperature to attain the desired viscosity and adhesive properties, which are crucial for the subsequent coating process 125.

Next, the dry water-retentive material 126, such as recycled cellulose sourced from industrial paper by-products, is saturated in the prepared coating solution 124. This step ensures thorough coating of the water-retentive material 126, enhancing its interaction with the metakaolin geopolymer slurry 110. At step 125, after saturation, excess solution is removed, and as an option, the coated material is cooled in a sealed environment to form a coated water-retentive aggregate 127, where a chitosan-pectin matrix adheres to the cellulose fibers. This step is critical, as the coated cellulose undergoes a reaction upon contact with the alkaline geopolymer slurry, leading to the formation of a hardened gel-like shell around the cellulose. This shell helps maintain the cellulose's structural integrity while preserving the slurry's workability.

To prepare aggregates, the coated water-retentive aggregate 127 is combined with a strength aggregate 150 and an aerating aggregate 141 in predetermined proportions. For example, one experimental mixture included 0.5 to 2 parts of the coated water-retentive aggregate 127 per 1 part of binder, 1 to 5 parts of the strength aggregate 150 per 1 part of binder, and 0.2 to 1 part of the aerating aggregate 141 per 1 part of binder. At step 128, these components are precisely weighed and mixed to achieve a uniform and homogeneous aggregate blend. Ensuring mixture uniformity is crucial for maintaining the structural integrity and consistency of the final concrete material 100.

In one embodiment, a metakaolin geopolymer slurry 110 is prepared by combining metakaolin 171 with an alkali-based activator 181. For example, a ratio of 35% metakaolin 171 to 60% alkali-based activator (K/Na silicate solution) 181 may be used. At step 402, these materials (171 & 181) are mixed at high speed, for e.g., 600 rpm, for 10 minutes. The controlled mixing ensures effective geopolymerization, facilitating the formation of an aluminosilicate gel network within the geopolymer slurry 110. This process is critical for achieving uniform mechanical properties, optimal rheology, appropriate workability, and the desired setting time of the hardened material.

Next, a 3% to 12% hydrogen peroxide solution 131 is gently incorporated into the slurry 110 at a ratio of 3% to 12%, introducing aeration to enhance porosity and improve the structural resilience of the final concrete. At step 404, this mixture is stirred at low speed, for e.g., 60 rpm for one minute. The final product is a geopolymer foam or binder 111, presented as an aerated metakaolin geopolymer slurry 110.

At step 128, the pre-prepared aggregates are gently incorporated into the geopolymer foam 111, ensuring uniform distribution. This mixture forms the foundational structure of the concrete matrix 100.

At step 160, the curing process begins as the concrete matrix is carefully poured into molds. The molds undergo vibration to eliminate air bubbles and ensure uniform distribution of the matrix. To retain moisture, the molds are then sealed. The concrete matrix 100 is cured in a controlled environment, specifically in an oven at approximately 80° C. for 24 hours. After curing, the material undergoes a cooling phase for about 6 hours, followed by a 24-hour dehydration phase to achieve the desired mechanical properties, resulting in cured dry concrete.

After the curing process at step 160, the cured dry concrete 161 undergoes a neutralization process 210. This involves immersion in a 1%-10% acetic acid solution for approximately 24 hours. Alternatively, the neutralization 210 can be performed using a boiling acetic acid solution for 6 hours. The process is repeated with sequential water rinses and immersion in dechlorinated water for about 12 hours until the concrete reaches a pH below 8. This results in pH-neutralized concrete 220, preparing its surface for organic growth. Additionally, the neutralization process 210 initiates the breakdown of the hardened shell surrounding the saturated cellulose, enhancing its water-retentive properties.

At step 301, photosynthetic organisms are transplanted onto the concrete surface. This process begins with applying a biological growth medium which acts as a moss adhesive 302 to the pH-neutralized concrete surface 220. The biological growth medium, which acts as a moss adhesive 302 and/or moss fragments 303, formulated from one or more of natural polysaccharides or dairy-based products, creates a suitable substrate for biological growth. This results in the formation of a living concrete 400, a unique concrete material capable of retaining water and sustaining biological growth.

In one embodiment, a geopolymer-based concrete composition 100 is engineered for water retention, bioactivity, and the self-sustaining maintenance of vegetated building envelopes and urban infrastructure. This formulation 100 prioritizes sustainability, offering construction materials that integrate with the natural environment. The advanced geopolymer matrices 100 enable superior water absorption and retention, along with enhanced chemical resistance, supporting the growth of photosynthetic organisms. Additionally, this disclosure presents a carbon-negative alternative to traditional concrete, promoting ecological sustainability while maintaining essential performance attributes such as strength and durability, which are critical for urban infrastructure applications.

In one embodiment, the matrix 100 integrates a geopolymer binder 110 with aggregates that provide structural support, water retention, and aeration. These aggregates enhance compressive strength while allowing for natural expansion and contraction, mitigating the effects of freeze-thaw stress. Designed to maintain structural integrity while promoting environmental sustainability, these embodiments facilitate urban greening by enabling the direct integration of living plants into the material's surface, thereby enhancing biodiversity and improving air quality in urban environments.

In one embodiment, incorporating industrial by-products into cement and aggregate production significantly reduces the carbon footprint of construction projects while minimizing the demand for potable water, which is typically required for manufacturing raw materials such as OPC and cellulose products. Additionally, the material's capacity to store rainwater helps mitigate stormwater runoff, providing a valuable resource for urban areas and municipalities.

With a robust and durable composition 100, these building materials are highly versatile and suitable for applications ranging from building facades to landscaping. This innovation marks a significant advancement in construction material technology, fostering environmental conservation and enhancing urban ecological health. Furthermore, integrated sensor arrays and artificial intelligence enable automated maintenance and environmental impact monitoring, optimizing long-term performance and sustainability.

In one embodiment, a comprehensive solution is provided through a water-retentive geopolymer matrix 100 integrated with monitoring systems. The key features of this embodiment include: (a) A geopolymer binder 110, composed of aluminosilicate precursors activated by alkali or acid solutions, significantly reducing carbon emissions compared to traditional cement. (b) Water-retentive aggregates 120, coated with biopolymers to enhance moisture retention, achieving at least 10% by weight, supporting biological activity without the need for conventional growing media. Additionally, post-curing pH neutralization 210 lowers surface alkalinity to below pH 8, creating a favorable environment for diverse biological growth, including mosses, lichens, and microalgae.

Embodiments provide a durable, low-carbon, multifunctional construction material and building system that facilitates sustainable urban greening while reducing installation and maintenance requirements compared to existing solutions. The geopolymer matrix, combined with an integrated monitoring system, offers multiple environmental benefits, including urban heat island mitigation, stormwater management, air quality improvement, and enhanced biodiversity.

### EXAMPLES

In the following examples, embodiments are described in more detail; however, all embodiments are not limited to the Examples.

### Example 1: End Product Manufacturing and Installation

After mixing all components in the manufacturing process, the next step is a wet-cast molding stage, where the liquid or semi-liquid mixture is poured into a mold. It is essential to ensure that the mixture is precisely leveled or slightly exceeds the mold's height to prevent overflow and spills. To minimize moisture loss during curing, the mold is wrapped in plastic and maintained at a humidity level of 95% or higher. This process allows the mixture to cure into molds of various shapes and sizes. Alternatively, the mixture can be cured in larger volumes and then cut into individual products, providing flexibility in production.

Product sizes vary depending on their intended use. For pavers, mold sizes range from 4 in.×4 in. (100 mm×100 mm) to 48 in.×48 in. (1200 mm×1200 mm), with thicknesses between 1.25 in. (30 mm) and 4 in. (100 mm). Panels range from 12 in.×12 in. (300 mm×300 mm) to 120 in.×60 in. (3000 mm×1500 mm), or larger, with thicknesses between 0.5 in. (12 mm) and 4 in. (100 mm). Tiles range from 4 in.×4 in. (100 mm×100 mm) to 48 in.×48 in. (1200 mm×1200 mm), with thicknesses between 0.25 in. (6 mm) and 1.5 in. (38 mm). Coatings are applied as continuous layers, with thicknesses ranging from 0.02 in. (0.5 mm) to 0.5 in. (12 mm), depending on the substrate and environmental exposure requirements.

While pedestal pavers, facade panels, roofing tiles, and surface coatings represent the largest market for architectural living products, other potential applications include but are not limited to, decorative tiles, retaining wall blocks, permeable pavers, interlocking pavers, stepping stones, cornices, moldings, ceiling panels, balustrades, railings, columns, capitals, archways, window surrounds, door surrounds, fireplace surrounds, mantels, street furniture, benches, planters, bollards, fountains, water features, sound barrier walls, textured concrete panels, and architectural relief panels.

The manufacturing process for pavers, panels, and tiles generally follows the same wet-cast molding method in sealed or high-humidity conditions. For coatings, if prefabricated using similar curing chambers as those for panels, tiles, and pavers, the process is largely the same. However, the viscosity of the mix is increased by adding and refining more aggregates or additives, allowing it to adhere to irregular surfaces and preventing dripping or spillage. If no curing chamber is available or the coating is applied in uncontrolled conditions, alternative porosity-engineering methods are used, such as adding aluminum powder for alkali-activated geopolymers or calcium carbonate for acid-activated geopolymers.

### Example 2: Installation, Applications, and Value Proposition for Low-Slope or Flat Roof Paver System

Low-Slope or Flat Roof Paver System is an elevated decking solution that utilizes either an adjustable or fixed substructure to support pavers, creating a level surface over an air gap. The air gap facilitates drainage and ventilation and protects the underlying waterproofing membrane. The living pavers serve as a cladding component in a system that includes, but is not limited to, the following:

The substructure is composed of pedestal systems made from polypropylene, polyethylene, aluminum, stainless steel, galvanized steel, or precast concrete. It also includes structural grid systems using materials such as aluminum, steel, fiberglass-reinforced plastic (FRP), high-density polyethylene (HDPE), or perforated/hollow-core concrete. Elevated decking systems incorporate materials like Ipe wood, thermally modified wood, cross-laminated timber (CLT), engineered wood, polymer-based composites, steel, aluminum, HDPE panels, or reinforced concrete slabs. Additionally, drainage spacer systems are made from polypropylene, HDPE, rubber, concrete, geosynthetic materials, composite drainage mats, porous ceramic spacers, or modular drainage panels.

Insulation options for the system include rigid boards such as polyisocyanurate, extruded polystyrene (XPS), expanded polystyrene (EPS), cellular glass, and phenolic foam. Mineral-based insulation options like rock wool, stone wool, perlite, and vermiculite, as well as fibrous insulation such as fiberglass batts, recycled denim, and wool, are also available. Spray foam insulation, including both closed-cell and open-cell spray polyurethane foam (SPF), and aerogel-based insulation, such as silica aerogels and aerogel blankets, are additional alternatives.

Air barriers in the system include self-adhered membranes, such as bituminous, rubberized asphalt, and polymeric sheets. Liquid-applied coatings like silicone, polyurethane, acrylic, and cementitious barriers, along with sheet membranes made of polyethylene, polypropylene, or laminated composites, are also used. Furthermore, spray-applied vapor-permeable coatings and elastomeric sealants are options for enhanced air sealing.

The vapor barriers consist of polyethylene sheets, polyvinyl chloride (PVC) sheets, bituminous membranes, laminated foil sheets, asphalt-coated kraft, and foil-faced papers. Breathable house wraps such as spun-bonded polyethylene (Tyvek) and polypropylene (Typar) are also utilized, as are fluid-applied barriers, including silicone-based coatings, rubberized asphalt emulsions, and elastomeric coatings.

Fasteners and anchors include mechanical anchors like kerf, masonry, expansion, wedge, sleeve, and undercut anchors. Screw fasteners are available in self-tapping, stainless steel, and corrosion-resistant coated options, along with bolt fasteners like galvanized, stainless steel, and chemical anchor bolts. Adhesive-based anchors such as epoxy, polyurethane, and acrylic adhesives are used, as well as rivets made from aluminum, stainless steel, or blind rivets.

Flashing materials include elastomeric solutions such as ethylene propylene diene monomer (EPDM) and rubberized asphalt, metal flashing options such as aluminum, stainless steel, copper, galvanized steel, and zinc, as well as composite flashing materials like bituminous membranes, reinforced polymer flashing, and self-adhered flashing tapes. Finally, ventilation cavities use battens and furring strips made from wood (treated lumber, cedar, redwood, hardwood), metal (aluminum, galvanized steel, stainless steel), or polymer-based composites. Ventilated rain screen systems with perforated aluminum panels, polymeric ventilated spacers, or pressure-equalized cavity systems are also implemented. Together, these components ensure structural integrity, moisture control, energy efficiency, and long-term performance in roof paver installations.

The system is suitable for a wide range of projects, including commercial, residential, institutional, infrastructure, and industrial applications. It serves as non-walkable cladding for extensive green roofs, stormwater management surfaces, and protective coverings. Common applications include office buildings, high-rises, schools, hospitals, transit hubs, warehouses, and mixed-use developments, where lightweight, elevated, and ventilated paver systems are essential. Additionally, the system is integrated into climate-adaptive roofing solutions, such as blue-green roofs, flood mitigation systems, and rooftop ecological installations.

Existing solutions include traditional concrete pavers and green roof systems. Conventional pavers, typically made from concrete, stone, or porcelain, are heavy, require structural reinforcement, and often depend on pedestal or ballasted systems for installation. While they offer durability, they lack ecological functionality and necessitate additional waterproofing layers. Traditional green roofs use modular trays, layered soil systems, or mat-based vegetation, along with synthetic membranes, drainage layers, and irrigation systems. These solutions are costly, heavy, and maintenance-intensive, often requiring reinforced structures and ongoing water management to sustain plant growth.

Living concrete pavers improve upon existing solutions by eliminating complex multi-layer assemblies. They replace traditional modular green roof trays, soil-based substrates, and drainage layers with a standalone, water-retentive paver or tile system. Unlike conventional pavers, which require structural reinforcement and offer no ecological benefits, these pavers provide an integrated, lightweight solution for non-walkable low-slope or flat roofs. They support self-sustaining vegetation growth without the need for soil, reducing system complexity and installation costs. Additionally, they protect roof membranes from UV radiation, thermal expansion, and freeze-thaw damage, extending the lifespan of the roof and reducing maintenance and replacement costs

### Example 3: Installation, Applications, and Value Proposition for Ventilated Building Facade Panel System

A ventilated building facade panel system is an exterior cladding assembly that creates a ventilated air gap between the building structure and the outer panels. The air gap facilitates moisture drainage and thermal regulation and enhances durability by preventing water infiltration and reducing material degradation.

The living panels serve as a cladding component in a system that includes but is not limited to, several key components. The substructure is made from materials such as aluminum, steel, stainless steel, galvanized steel, pressure-treated wood, engineered wood, and plastic wood. Insulation options include polyisocyanurate, extruded polystyrene (XPS), expanded polystyrene (EPS), rock wool, fiberglass, cellular glass, and phenolic foam. Air barriers are composed of self-adhered membranes, liquid-applied coatings, and sheet membranes, while vapor barriers include polyethylene sheets, asphalt-coated papers, laminated foil sheets, and breathable house wraps like spun-bonded polyethylene (Tyvek) and polypropylene (Typar).

The system also utilizes fasteners and anchors, such as kerf anchors, masonry anchors, expansion anchors, screws, bolts, and rivets, and flashing made from ethylene propylene diene monomer (EPDM) and rubberized asphalt. A ventilation cavity is created with battens and furring strips made from wood (treated lumber, cedar, redwood, hardwood), metal (aluminum, galvanized steel, stainless steel), or polymer-based composites. Various attachment methods are employed, including kerf anchors, which slot into rails for concealed fastening; undercut anchor systems, which embed anchors into precision-drilled holes on the panel's rear face for high-load concealed attachment; hook-on systems, which use T-slot or J-slot hooks with preinstalled brackets that engage rails for adjustable design flexibility; face-fixed systems, which use screws, rivets, or bolts that penetrate the panel and attach to support rails for high wind-load resistance; and adhesive and hybrid systems, which bond panels with high-strength adhesives, supported by mechanical backups for redundancy and safety.

This system is suitable for a wide range of commercial, residential, institutional, and infrastructure projects, including high-rise buildings, office facades, public spaces, transit hubs, cultural institutions, and mixed-use developments, where ventilated, lightweight, and modular facade systems are needed. Additionally, the system is integrated into climate-adaptive architecture, such as green infrastructure, urban ecological restoration, and modular prefabrication projects.

Traditional green facade systems typically rely on plastic planters with vascular plants, which are flammable, require irrigation, and demand structural reinforcements to support soil-based plantings. Conventional rain-screen panels lack biological functionality while climbing plant systems necessitate support structures, intensive maintenance, and extended establishment periods.

The non-combustible geopolymer composition of the living panels offers exceptional fire resistance, preventing flame spread due to its inorganic properties and eliminating the need for additional fire breaks in high-rise applications. It also reduces the impact of expansion and contraction cycles, minimizing stress on building envelopes. The system creates aesthetic green facades, supporting self-sustaining vegetation growth without the need for soil, structural reinforcements, or extensive maintenance. Furthermore, it extends the lifespan of building materials by protecting surfaces from UV radiation, thermal expansion, and freeze-thaw damage, reducing maintenance and replacement costs. The panels can be installed using various methods, including kerf anchors, undercut anchors, hook-on systems, face-fixed systems, and adhesive/hybrid systems, ensuring compatibility with modular prefabrication for fast installation and retrofitting in building facades, infrastructure, and noise barrier systems.

### Example 4: Installation, Applications, and Value Proposition for Steep-Slope or Pitched Roof Title System

Steep-slope or pitched roof tile system is a tile-based green roof solution designed for sloped applications. It integrates capillary-driven moisture retention without adding excessive weight, enabling seamless integration with conventional roofing materials. The system provides a non-walkable, self-cooling surface that contributes to stormwater management, heat regulation, and long-term roof durability.

The living tiles function as the cladding component in a modular system that includes, but is not limited to, several key components: a substructure made from materials such as aluminum, steel, stainless steel, galvanized steel, pressure-treated wood, engineered wood, and polymer-based composites; interlocking tile configurations for seamless installation on pitched roofs; insulation composed of polyisocyanurate, extruded polystyrene (XPS), expanded polystyrene (EPS), rock wool, fiberglass, cellular glass, and phenolic foam; air barriers including self-adhered membranes, liquid-applied coatings, and sheet membranes; vapor barriers such as polyethylene sheets, asphalt-coated papers, laminated foil sheets, and breathable house wraps like spun-bonded polyethylene (Tyvek) and polypropylene (Typar); fasteners and anchors including screw fasteners, concealed clips, interlocking brackets, expansion anchors, and rivets; flashing made from materials like ethylene propylene diene monomer (EPDM), rubberized asphalt, aluminum, stainless steel, copper, galvanized steel, and zinc; and a ventilation cavity utilizing battens, furring strips, and spacer systems made from wood, metal, or polymer-based composites.

The system is suitable for residential and commercial steep-slope roofing applications, including single-family homes, townhouses, multi-family housing, low-rise commercial buildings, and cultural institutions. It is also well-suited for climate-adaptive roofing solutions, such as eco-friendly sloped roofs, stormwater management systems, and other sustainable architectural applications. Traditional pitched roof materials, such as asphalt shingles, clay tiles, concrete tiles, and metal panels, offer durability but lack integrated ecological functionality. Standard green roof systems, on the other hand, are generally limited to flat or low-slope applications. These systems often require heavy soil-based substrates, drainage layers, and irrigation, making them impractical for steep roofs.

Living concrete roof tiles replace traditional roofing materials with a lightweight, water-retentive system, eliminating the need for soil-based green roof assemblies on steep slopes. Unlike conventional roofing, these tiles offer integrated moisture retention, creating self-cooling surfaces that help reduce attic and upper-level indoor temperatures. The system also enhances stormwater absorption, acting as a decentralized rainwater management solution. It is compatible with conventional mounting rails and underlayment, allowing for easy retrofitting or integration into new construction. The wind-resistant design can withstand uplift loads in hurricane-prone regions, improving structural performance while supporting self-sustaining plant growth without the need for irrigation or additional support systems. Furthermore, the system extends the roof lifespan by shielding surfaces from UV radiation, thermal expansion, and freeze-thaw damage, ultimately reducing long-term maintenance and replacement costs.

### Example 5: Installation, Applications, and Value Propositions for Architectural Coating System

Spray- or hand-applied coating functions similarly to stucco but incorporates moisture-retentive, bio-receptive components, making it ideal for large-scale infrastructure projects such as highway noise barriers, tunnel linings, and retaining walls. The coating system is particularly suited for applications where noise reduction, air quality improvement, and urban cooling are key priorities. It can be specified for municipal and commercial developments to help mitigate urban heat island effects, enhance stormwater management, and provide a low-maintenance, ecologically functional facade. With its lightweight composition, absence of supplemental irrigation, and rapid trowel- or spray-based installation, the system is equally effective for retrofitting existing structures or integrating into new construction.

The living concrete coating serves as the finishing layer in a modular system that includes but is not limited to, substrate preparation (such as surface cleaning, priming, or roughening of cast-in-place concrete, shotcrete, CMU blocks, or steel surfaces); a base coat (scratch coat) made from a geopolymer binder and sand; and the living concrete finish coat. Optional components include fasteners and anchors (mechanical or adhesive-based systems) for secure attachment where needed, as well as moisture management strategies, such as integrated drainage channels or vented interfaces, to optimize hydration and longevity across various climates. Additionally, reinforcement and lath systems, such as galvanized expanded metal lath, fiberglass mesh, or synthetic lath, may be used for enhanced adhesion, attached with corrosion-resistant fasteners.

Traditional stucco or plaster-based barriers focus primarily on aesthetics and weather resistance without offering environmental functionality. Similarly, conventional green walls rely on engineered substrates, complex irrigation systems, and ongoing maintenance, making them cost-prohibitive for highway or tunnel applications due to their weight and high water demands.

By combining the efficiency of stucco application with living concrete technology, this system offers multi-functional performance benefits, including noise attenuation, passive air filtration, and ecological enhancement, without the structural and operational challenges of traditional living wall systems. The spray or trowel application method reduces installation time and labor costs, while its self-sustaining nature minimizes long-term maintenance, making it a cost-effective solution for sustainable infrastructure development.

### Example 6: Monitoring and Irrigation

The automated irrigation monitoring system integrates environmental sensing, data analytics, and targeted watering to maintain optimal plant health. By collecting real-time data on microclimate factors such as wind speed, temperature, and humidity, along with plant conditions through RGB, infrared thermal, and hyperspectral imagery, the system dynamically adjusts irrigation levels to support vegetation with minimal manual intervention.

Embedded sensors (measuring wind speed, ambient temperature, relative humidity, and utilizing multispectral cameras) continuously transmit data to a microcontroller or industrial Programmable Logic Controller (PLC), ensuring reliable data acquisition and connectivity. The PLC or microcontroller interfaces with a data processing platform, where remote user input or machine learning algorithms interpret sensor readings and detect early signs of plant stress. When predefined thresholds are met, misting emitters or irrigation controllers are activated for precise, on-demand watering. Remote control capabilities and cloud-based data storage further enable comprehensive monitoring, advanced analytics, and full system automation.

Traditional irrigation methods depend heavily on manual inspection, requiring personnel to visit each site to assess plant health and water needs. Even systems with basic timers often lead to overwatering or underwatering due to a lack of real-time data on changing environmental conditions. This time-intensive, manual approach can result in water waste, inconsistent plant performance, and delayed responses to emerging stress factors.

By replacing guesswork and routine site visits with automated, data-driven irrigation, the system conserves water, reduces labor costs, and enables quicker intervention in response to plant stress or changing weather conditions. In addition to supporting healthier vegetation, the collected data contribute to broader ecological management, refining species distribution models, guiding biodiversity initiatives, and supporting large-scale urban greening efforts.

### Example 7: Collected Data to Train Species Distribution Models

System leverages real-time, high-fidelity environmental and biological data to train advanced species distribution models (SDMs). By integrating microclimate metrics such as temperature, humidity, soil moisture, pH, solar radiation, air quality (measured through various sensors), wind speed, and more, along with remote sensing imagery (multispectral, hyperspectral, infrared, LIDAR), and biological observations (including species presence and phenological data), the approach captures detailed habitat dynamics. The resulting SDMs surpass the accuracy of traditional low-resolution models by continuously adapting to rapid changes in local conditions, providing more precise habitat suitability forecasts for conservation, restoration, and land-use planning. The core hardware consists of a distributed sensor network, including meteorological stations, embedded probes, stationary cameras, and drone-based sensors, all connected to microcontrollers or industrial edge computing devices for on-site data aggregation and preliminary analysis. These devices interface with cloud-based or high-performance computing (HPC) platforms, which host machine-learning pipelines optimized for ecological datasets. An automated feedback loop continuously refines model parameters based on newly acquired data, ensuring ongoing model evolution and minimal latency in detecting environmental changes.

Historically, species distribution models have relied on sparse, low-resolution climate datasets, broad land cover classifications, and infrequent field observations, leading to generalized predictions with limited local accuracy. Research teams often use static, multi-year averages that fail to capture ephemeral events, such as sudden droughts or extreme weather, as well as microclimatic variations critical for certain keystone or sensitive species. This results in suboptimal habitat management, inefficient resource allocation, and potentially misleading outcomes for conservation efforts.

By providing near-real-time, fine-scale insights into habitat suitability, the system equips researchers, land managers, and policymakers with early warning signals and data-driven decision support. Accurate microclimate tracking and timely species detection help mitigate habitat degradation, guide targeted interventions, and enable proactive conservation strategies. Moreover, adaptive models, continuously refined through sensor feedback, reduce uncertainty, enhance resilience planning, and support cost-efficient resource management in climate-vulnerable regions.

Beyond ecology and conservation, high-resolution SDMs have broad applications in agriculture (optimal crop placement, pest control strategies), forestry (reforestation site selection, invasive species forecasting), urban planning (designing pollinator corridors, assessing green roof viability), and insurance markets (risk modeling based on habitat susceptibility). They can also support carbon offset projects by identifying areas most suitable for reforestation or wetland restoration, helping stakeholders achieve sustainability goals with greater precision and transparency.

### Example 8: Technology Impact and Benefits

Embodiments offer a scalable, modular system that tackles a range of urban environmental challenges by utilizing geopolymer-based building materials integrated with biological growth support. Exposed to atmospheric conditions such as sun, rain, wind, and ambient moisture, the system helps lower facade temperatures through water retention and transpiration, mitigating the urban heat island effect and improving local microclimates. Optional enhancements, such as mist or drip irrigation and water-resistant pans for directing rainwater to the panels, further optimize its performance.

The photosynthetic organisms and plants within the system have the ability to detoxify the air by removing heavy metals, particulate matter (PM2.5, PM10), and gaseous pollutants such as NOx and SO₂. The system also provides decentralized stormwater management, reducing peak runoff and helping to prevent localized flooding. Its porous structure and vegetative layer attenuate traffic and industrial noise, thereby mitigating sound pollution. Specifically designed to support urban biodiversity, the system creates microhabitats for pollinators, mosses, and other species that thrive without soil or irrigation. Its modular design allows seamless integration into noise barrier assemblies or prefabricated construction elements, accelerating installation and minimizing on-site labor.

One benefit of one embodiment is a geopolymer matrix that offers superior fire resistance and thermal stability compared to polymeric or composite facade materials. Being inorganic and inherently non-combustible, it significantly delays flame spread due to its high moisture retention properties, providing passive fire protection ideal for high-rise buildings. Additionally, the system actively sequesters carbon through photosynthesis by mosses and other small organisms, helping to reduce CO₂ in the atmosphere. The extended service life of geopolymer materials, often exceeding 100 years, ensures long-term durability and sustainability, enhanced by superior freeze-thaw resilience, UV stability, and improved acid resistance. Furthermore, the recyclable nature of geopolymer-based products, along with their compatibility with alternative precursors like blast furnace slag and fly ash, reduces embodied carbon and supports circular economy practices.

Compared to traditional Portland cement concrete, the geopolymer formulations disclosed herein can reduce embodied carbon by 30% to 95%, depending on the selected precursors. Additional environmental benefits include reduced building energy consumption through evapotranspiration, lower solar heat gain due to surface moisture, as well as further mitigation of the urban heat island effect via plant shading and a naturally low Solar Reflective Index. When integrated into urban environments, these panels enhance biodiversity and air quality without the need for added structural supports, active water systems, or the high maintenance typically required by conventional vertical gardens, offering a more space-efficient and low-maintenance alternative.

The system's modular, lightweight design enables easy retrofitting and new installations, minimizing labor costs and ensuring rapid deployment. With minimal irrigation and fertilizer needs, it is particularly well-suited for urban greening initiatives. Over several weeks, mosses, lichens, and algae naturally colonize the geopolymer surface, provided the appropriate humidity, temperature, and pH conditions are met. Once fully established, these organisms create self-sustaining ecosystems that enhance local biodiversity. The system also supports essential ecosystem services, including particulate filtration, noise reduction, and habitat creation, while contributing to lower infrastructure maintenance and prolonging the lifespan of structures.

Embodiments are suitable for a range of applications, including roofing, facade cladding, and infrastructure surfaces such as noise barriers, ensuring seamless integration with existing construction methods. Its multifunctional capabilities offer significant energy savings, stormwater management, and potential carbon credit benefits, making it an economically attractive solution for widespread adoption. Optional sensor-based monitoring can be incorporated to track moisture levels, pollutant capture, and overall system health, enabling data-driven maintenance schedules and optimizing ecological performance.

While the disclosure has been described with reference to exemplary embodiments, it will be understood by those skilled in the art that various changes may be made, and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting to the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application and to enable others of ordinary skill in the art to understand the disclosure for various embodiments with various modifications as are suited to the particular use contemplated.

What is claimed is:

1. A concrete composition comprising:
a geopolymer binder;
one or more water-retentive aggregates capable of long-term water retention and facilitating biological surface growth, wherein at least one of the water-retentive aggregates is cellulose pre-treated with a saturating coating solution;
one or more rigid, porous, aeration aggregates; and
one or more strength aggregates.

2. The concrete composition of claim 1, comprising an alkaline solution, which is a component of the geopolymer binder.

3. The concrete composition of claim 1, further comprising hydrogen peroxide.

4. The concrete composition of claim 1, further comprising a biological growth medium is a biodegradable adhesive layer, comprising one or more of natural polysaccharides or dairy-based products, that are affixed to the concrete composition in a cured state.

5. The concrete composition of claim 1, wherein the cellulose comprises recycled cellulose.

6. A method of forming a cured building material, the method comprising:
mixing: a geopolymer binder; one or more water-retentive aggregates capable of long-term water retention and facilitating biological surface growth, wherein at least one of the water-retentive aggregates is cellulose pre-treated with a saturating coating solution; one or more rigid, porous, aeration aggregates; and one or more strength aggregates, thereby forming a pourable building material;
pouring the pourable building material, and
curing the pourable building material in a controlled environment, to form a cured building material in a cured state.

7. The method of claim 6, comprising an alkaline solution, which is a component of the geopolymer binder.

8. The method of claim 6, further comprising, with the cured building material in the cured state, acid washing a hardened shell of the water-retentive aggregates.

9. The method of claim 6, further comprising the step of: incorporating hydrogen peroxide during mixing, in the pourable building material to induce aeration.

10. The method of claim 6, further comprising, after curing, applying an acid wash to neutralize the pH of the cured building material.

11. The method of claim 10, further comprising:
applying a biological growth medium containing any of natural polysaccharides or dairy-based products;
affixing the biological growth medium via its biodegradable adhesive mechanism, to a surface of the cured building material.

12. The method of claim 6, wherein the cellulose comprises recycled cellulose.

13. A geopolymer-based construction material comprising:
an aluminosilicate precursor;
an activator;
water-retentive aggregates with a biopolymer coating; and
a porosity agent,
having water retention above 10% by weight and a pH below 8.0.

14. The material of claim 13, wherein the water-retentive aggregates comprise one or more of cellulose, peat moss, coconut coir, biochar, zeolites, or adjacent organic matter and minerals; wherein the biopolymer coating incorporates chitosan.

15. The material of claim 13, wherein the aluminosilicate precursor comprises metakaolin, Class F fly ash, slag, volcanic ash, rice husk ash, or red mud.

16. The material of claim 13, wherein the activator comprises an alkali solution containing sodium silicate, potassium silicate, or a combination thereof with a Na/K ratio between 1:1 and 3:1, or an acid solution containing phosphoric acid, sulfuric acid, or a combination of phosphoric acid and sulfuric acid.

17. The material of claim 13, wherein the porosity agent comprises any of hydrogen peroxide, baking soda, aluminum powder, vermiculite, perlite, expanded clay, or expanded shale.

18. A process of manufacturing a geopolymer-based construction material as recited in claim 13, the process comprising:
forming a mixture by mixing the aluminosilicate precursor with the activator;
adding the water-retentive aggregates with the biopolymer coating;
introducing the porosity agent;
curing the mixture; and
after curing, neutralizing the mixture to a pH below 8.0.

19. The process of claim 18, wherein the curing comprises maintaining the mixture at 60° C.-90° C. for 2 hours-72 hours; wherein the neutralizing comprises applying an acid wash with 1%-10% acetic or citric acid for 24 hours-48 hours at ambient temperature or 2 hours-12 hours at 60° C.-100° C.

20. A building system comprising:
a plurality of building elements formed of the geopolymer-based construction material as recited in claim 13;
a plurality of environmental sensors;
an irrigation system, and
mounting and installation mechanisms.

21. The building system of claim 20, wherein the plurality of building elements comprises a plurality of roof pavers, facade panels, roofing tiles, or infrastructure surface coatings.

22. The building system of claim 20, wherein the plurality of environmental sensors includes any of wind speed sensors, ambient temperature sensors, relative humidity sensors, RGB cameras, IR thermal cameras, or hyperspectral cameras.

23. The building system of claim 20, wherein the irrigation system comprises one or more drip or misting emitters controlled by a system that uses sensor data and machine learning algorithms to determine activation.
